(19) United States
(12) Patent Application Publication
(10) Pub. No.: US 2006/0152788 A1
(43) Pub. Date: Jul. 13, 2006

(54) Optical scanner and image forming apparatus including optical scanner

(76) Inventor: Yoshio Kaneko, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/320,720

(22) Filed: Dec. 30, 2005

(30) Foreign Application Priority Data
Jan. 11, 2005 (JP) 2005-004039
Oct. 14, 2005 (JP) 2005-299809

(51) Int. Cl. G02B 26/08

(52) U.S. Cl. 359/218

(57) ABSTRACT

In an optical scanner, a scanning and imaging optical system is fitted to an optical housing. The optical housing includes a seat that has a holding surface for holding a condenser lens. A ridge at each of opposite ends on the holding surface of the seat is linear in the horizontal scanning direction, but a portion of each ridge immediately below where the light beams pass through the condenser lens is substantially not parallel to a path of the light beams.

### CROSS-REFERENCE TO RELATED APPLICATIONS

The present document incorporates by reference the entire contents of Japanese priority documents, 2005-004039 filed in Japan on Jan. 11, 2005 and 2005-299809 filed in Japan on Oct. 14, 2005.

### BACKGROUND OF THE INVENTION

1. Field of the Invention

The present invention relates to a lens fixing structure for fixing a condenser lens to an optical housing, in an optical scanner of an image forming apparatus such as an electro-photographic copying machine, a facsimile machine, a printer, and a multifunction product thereof.

2. Description of the Related Art

A configuration and operation of the electro-photographic copying machine as a conventional image forming apparatus are explained with reference to FIGS. 10 to 14. FIG. 10 is a cross section of an overall structure of the copying machine, FIG. 11 is a cross section of a scanner (image reader) equipped in the copying machine, FIG. 12 is a perspective view of an optical scanner (laser beam scanner) equipped in the copying machine, FIG. 13 is a plan view of a lens fitting unit in the optical scanner, and FIG. 14 is a cross section of FIG. 13.

The copying machine shown in FIG. 10 includes a document reader (scanner) 11, a printer 12 having an optical scanner (laser beam scanner) 70A, and an automatic document feeder 13. The automatic document feeder 13 carries a document set thereon one by one to set the document on a contact glass 14, and ejects the document on the contact glass 14 after copying is complete.

As shown in FIG. 11, the document reader 11 includes a first carriage A and a second carriage B. A light source including an illumination lamp 15 and a reflector 16, and a first mirror 17 are equipped on the first carriage A, and a second mirror 18 and a third mirror 19 are equipped on the second carriage B.

At the time of reading the document, the first carriage A moves at a certain speed, and the second carriage B follows the first carriage A at a speed half of the first carriage A, and thus, the document on the contact glass 14 is scanned optically. The illumination lamp 15 and the reflector 16 illuminate the document, and a reflected optical image thereof is formed on a charge coupled device (CCD) sensor 22 by a lens 21, via the first mirror 17, the second mirror 18, the third mirror 19, and a color filter 20. The CCD sensor 22 photo-electrically converts the reflected optical image of the document to output an analog image signal, thereby reading the document. After the image reading is complete, the first carriage A and the second carriage B return to their home position.

The analog image signal from the CCD sensor 22 is converted to a digital image signal by an AD converter, and subjected to various kinds of image processing (binarization, multi-level processing, toning, scaling, editing, and the like) by an image processing substrate 23. By using a 3-line CCD with red (R), green (G), and blue (B) filters as the CCD sensor, color documents can be read as well.

In the printer 12, a photosensitive drum (image carrier) 25 is rotated by a drive unit (not shown) at the time of copying, and uniformly charged by a charger 26. A digital image signal subjected to image processing on the image processing substrate 23 is then fed to a semiconductor drive board (not shown), and the optical scanner 70A carries out image exposure by the digital image signal, to form an electrostatic latent image on the photosensitive drum 25. Furthermore, the electrostatic latent image on the photosensitive drum 25 is developed to a toner image by a development apparatus 28.

Transfer paper (not shown) is fed to a resist roller pair 36 from a selected one of paper feeders 33 to 35. The transfer paper is fed from the resist roller pair 36 at a timing matched with the image on the photosensitive drum 25, and the toner image formed on the photosensitive drum 25 is transferred onto the transfer paper by a transfer apparatus 30. The transfer paper is separated from the photosensitive drum 25, carried by a carrying unit 37, the transferred image is fixed by a fixing unit 38, and the transfer paper is ejected onto a tray 39. After the transfer paper has been separated, a cleaning device 32 cleans the photosensitive drum 25 to remove the residual toner.

As shown in the perspective view in FIG. 12, in the optical scanner 70A that carries out image exposure, laser beams emitted from a semiconductor laser in a semiconductor laser apparatus 40 are converted to parallel beams by a collimate lens in the semiconductor laser apparatus 40, pass through an aperture provided in the semiconductor laser apparatus 40, and are reshaped to beams of a fixed shape. The beams are compressed in a vertical scanning direction by a cylindrical lens 40a, and are incident on a polygon mirror 42. The polygon mirror 42 has an accurate polygonal shape, and is driven by a polygon motor 41 (see FIG. 10) at a constant speed in a fixed direction. The rotation speed of the polygon mirror 42 is determined by a rotation speed of the photosensitive drum 25, a write density of the optical scanner 70A, and the number of planes of the polygon mirror 42.

The laser beams incident on the polygon mirror 42 from the cylindrical lens 40a are deflected by a reflecting surface of the polygon mirror 42 and enter into an fθ lens (condenser lens) 43. The fθ lens 43 converts the beams so that the scanning beams at a constant angular velocity from the polygon mirror 42 are scanned at a constant velocity on the photosensitive drum 25. The laser beams from the fθ lens 43 are imaged on the photosensitive drum 25 via a reflector 45 and a dustproof glass 46. The fθ lens 43 also has a cross-scan error compensation function. The laser beams having passed through the fθ lens 43 are reflected by a synchronism detection mirror 47 outside of an image area, and guided to a synchronism detection sensor 48. A synchronism signal, which becomes a basis for looking up the beginning in a horizontal scanning direction, can be obtained from the output of the synchronism detection sensor 48.

An air intake fan 24 is arranged below one end of the document reader 11, and a blower 90 is arranged near the development apparatus 28 in the printer 12. The outside air sucked by the intake fan 24 via an external cover flows toward the image processing substrate 23 through the document reader 11, and is discharged to the outside of the copying machine. Accordingly, the optical system (optical parts) in the document reader 11 is cooled. The outside air sucked by the blower 90 via the external cover cools the periphery of the photosensitive drum 25, and then cools the polygon motor 41 and the optical system in the optical scanner 70A.

Various types of lens fixing structures have been proposed and implemented as a lens fixing structure for fixing the condenser lens, that is, a scanning lens (hereinafter, also referred to as “lens”), included in the scanning and imaging optical system, to an optical housing. Conventionally, while positioning and fixing of the lens is carried out by using a portion corresponding to the inside of the image area of the lens, when the lens comes into direct contact with the optical housing ((hereinafter, also referred to as “housing”), the lens is fitted to the housing via an adhesive layer.

In the example shown in FIGS. 13 and 14, a condenser lens 101 in the optical scanner is fitted as shown. The central part of the condenser lens 101 is fitted by adhesion using an adhesive 104, to a seat portion 103 (hereinafter, also referred to as “seat”) for bonding the condenser lens. The seat portion 103 is provided in a housing 102 and has substantially rectangular shape. Beams 49A and 49B indicate beams respectively passing through positions (ridges) at the opposite ends of the condenser lens 101 in a longitudinal direction, at the ends of the adhesive 104 of the seat portion 103, that is, at the edges (ridges) of the upper surface of the seat.

The inside of the housing 102 is normally in a sealed state, however, the thermal environment of the housing changes violently during the use of the image forming apparatus (immediately after the startup of the image forming apparatus, after a continuous printing operation, or in a standby mode, or when a cooling condition inside the housing is changing). With a change in the ambient temperature, the temperature in the housing gradually approaches the ambient temperature.

The temperature of the housing itself largely changes as compared to a temperature change inside of the housing, due to being directly exposed to the peripheral environment. Therefore, the lens 101 in the housing fitted adjacent to a part of the housing, or fitted to a part of the housing by the adhesive is largely affected by the temperature change of the housing, and hence, the temperature of the lens 101 changes locally. Particularly, there is a large temperature deviation between a portion of the lens 101 that comes into contact with the housing 102 at the seat portion 103, and a portion where the lens 101 does not come into contact with the housing. The condenser lens 101 is a long lens made of plastic, and the refractive index of the plastic changes with temperature. If the condenser lens 101 is affected by the temperature deviation, a difference (a deviation) in the refractive index occurs locally in the lens. A deviation in the refractive index increases at a boundary between the portion of the lens in contact with the housing (the upper part of the seat portion 103) and the portion not in contact with the housing.

On the other hand, the beams are condensed to a minute spot (several tens micrometers) on the photoconductor. However, the beams on the condenser lens are not in a condensed state, and have a certain width (several millimeters). Furthermore, the beams deflected by a deflector enter into the condenser lens 101 substantially radially, centering on a specular point of the deflector. The beams at the time of passing through the end of the seat portion 103 for lens bonding of the housing 102 in the condenser lens 101, that is, beams passing through a position corresponding to the ridge of the seat (49A or 49B in FIG. 14) are such that a part of the beams passes through the portion in contact with the housing, and a part of the beams passes through the portion not in contact with the housing. Therefore, there is a temperature deviation in the condenser lens at a boundary between the portion in contact with the housing and the portion not in contact with the housing. When there is a deviation in the refractive index of the lens, the beams passing through the position (the ridge of the seat) causes a disorder in the condensing state on the photoconductor.

When the seat of the housing for bonding the condenser lens has a rectangular shape as in the conventional technology, the beams passing through the position corresponding to the edge (ridge) of the seat have to pass through a portion spanning over the portion in contact with the housing and the portion not in contact with the housing for a long distance, because the beams and the ridge lines of the seat are substantially parallel to each other. Accordingly, the beams are largely affected by the temperature deviation, thereby easily causing local deterioration in the optical characteristics. Consequently, the image quality of the portion corresponding to the deteriorated portion degrades, thereby causing a problem in that continuous marks appear in the vertical scanning direction.

Finally, under a condition of stable use of the image forming apparatus, and when the ambient temperature of the housing, the temperature of the housing itself, and the temperature inside of the housing all become stable, there is no local temperature gradient in the condenser lens and the like, and the optical characteristics thereof are stable, thereby enabling to acquire favorable images. In other words, when the environmental temperature around the housing changes suddenly, for example, when the mode of use of the image forming apparatus changes, a problem in the image quality such as above is likely to occur.

Japanese Patent Application Laid-open No. 2004-74627 discloses a technique relating to the condenser lens fixing structure in the scanning and imaging optical system, which is hardly affected by the environmental change in the ambient temperature of the optical housing. According to this technique, the thermal influence on the lens from the optical housing is alleviated by providing a separate member (bonding member) between the lens and the optical housing, and fixing the lens to the optical housing. However, there is no particular reference to the end shape (ridge shape) of the lens bonding portion, and in one embodiment, the lens bonding portion has a conventional rectangular shape. Therefore, the beams passing through the portion of the lens corresponding to the ridge and the end shape (ridge line) of the lens-bonding portion are substantially parallel to each other.

### SUMMARY OF THE INVENTION

It is an object of the present invention to at least solve the problems in the conventional technology.

According to one aspect of the present invention, an optical scanner includes a light source that emits light beams; an optical deflector that deflects the light beams; an optical housing; a photoconductor; and a scanning and imaging optical system fitted to the optical housing, and into which deflected light beams enter, and which condenses the light beams as an optical spot on the photoconductor; where the scanning and imaging optical system includes a condenser lens that is longer in a horizontal scanning direction, the light beams passing through the condenser lens, the optical housing includes a seat that has a holding surface for holding the condenser lens, and a ridge at each of opposite ends on the holding surface of the seat is linear in the horizontal scanning direction, and a portion of each ridge immediately below where the light beams pass through the condenser lens is substantially not parallel to a path of the light beams.

According to another aspect of the present invention, an image forming apparatus includes an image forming unit equipped with an optical scanner, where the optical scanner includes a light source that emits light beams; an optical deflector that deflects the light beams; an optical housing; a photoconductor; and a scanning and imaging optical system fitted to the optical housing, and into which deflected light beams enter, and which condenses the light beams as an optical spot on the photoconductor; where the scanning and imaging optical system includes a condenser lens that is longer in a horizontal scanning direction, the light beams passing through the condenser lens, the optical housing includes a seat that has a holding surface for holding the condenser lens, and a ridge at each of opposite ends on the holding surface of the seat is linear in the horizontal scanning direction, and a portion of each ridge immediately below where the light beams pass through the condenser lens is substantially not parallel to a path of the light beams.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a fixing structure for fixing a condenser lens to an optical housing according to a first embodiment of the present invention;

FIG. 2 is a cross section of FIG. 1;

FIG. 3 is a plan view of a fixing structure for fixing a condenser lens to an optical housing according to a second embodiment of the present invention;

FIG. 4 is a plan view of a fixing structure for fixing a condenser lens to an optical housing according to a third embodiment the present invention;

FIG. 5 is a plan view of a fixing structure for fixing a condenser lens to an optical housing according to a fourth embodiment of the present invention;

FIG. 6 is a cross section of FIG. 5;

FIG. 7 is a cross section of a fixing structure for fixing a condenser lens to an optical housing according to a fifth embodiment the present invention;

FIG. 8 is a cross section of a fixing structure for fixing a condenser lens to an optical housing according to a sixth embodiment of the present invention;

FIG. 9 is a plan view of a fixing structure for fixing a condenser lens to an optical housing according to a seventh embodiment of the present invention;

FIG. 10 is a cross section of an overall structure of a conventional electro-photographic copying machine;

FIG. 11 is a cross section of a scanner equipped in the electro-photographic copying machine shown in FIG. 10;

FIG. 12 is a perspective view of an optical scanner (a laser beam scanner) equipped in the electro-photographic copying machine shown in FIG. 10;

FIG. 13 is a plan view of a lens fitting unit in the optical scanner shown in FIG. 12; and

FIG. 14 is a cross section of FIG. 13.

### DETAILED DESCRIPTION OF THE PREFERRED EMBODIMENTS

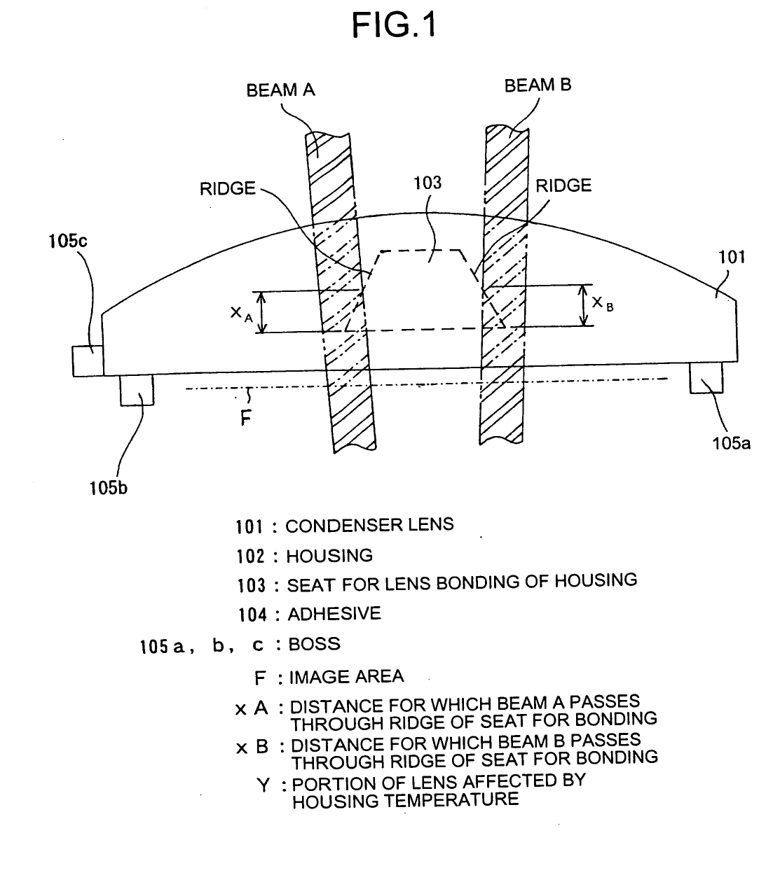

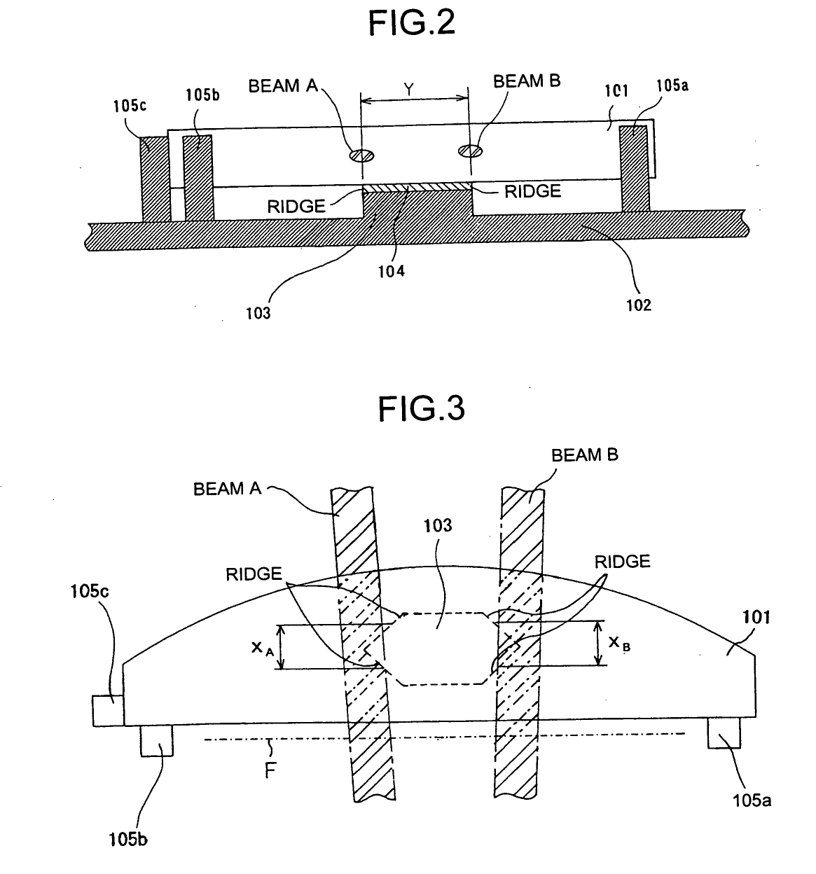

Exemplary embodiments of the present invention are explained in detail below with reference to the accompanying drawings, along with a configuration procedure. FIG. 1 is a plan view of a structure for fixing a well-known condenser lens (scanning lens) 101, which has a semi-cylindrical planar shape (horizontal cross section) and a short columnar shape, to an optical housing (also referred to as “housing”), and FIG. 2 is a cross section thereof. FIG. 1 depicts a top view of the condenser lens 101, and a seat portion 103 (condenser lens-holding surface) is shown by a dotted line. Because the outline of the optical scanner and the image forming apparatus has been already explained, the explanation thereof is omitted, and the lens-fixing structure for the optical scanner is mainly explained below.

Bar-shaped bosses 105a, 105b, and 105c protrude near the ends of the bottom surface of an optical housing 102, away from an image area F of the condenser lens 101. The central part of the condenser lens 101 is bonded to the seat portion 103 for bonding, which is formed at a position corresponding to the bottom part of the image area F, on the surface of the optical housing 102, by an adhesive 104 (for example, a ultraviolet curing adhesive).

The seat portion 103 holds the condenser lens 101 at a certain height away from the bottom face of the optical housing 102, and has a columnar shape protruding from the bottom face of the optical housing 102, with the top thereof being a condenser lens-holding surface having a certain area. The shape of the condenser lens-holding surface of the seat portion 103 of the housing for holding and bonding the condenser lens is different from the conventional rectangular shape, such that the opposite ends thereof in the horizontal scanning direction of the scanning beams (the ends in the longitudinal direction) are not parallel to the direction of the beams passing through the position.

The boss 105c is a positioning member in the longitudinal direction of the condenser lens 101, and the bosses 105a and 105b are positioning members in a transverse direction. The condenser lens 101 is placed in position by abutting one end of the condenser lens 101 to the boss 105c in the longitudinal direction, and abutting the planar portion, which is one side in the transverse direction, to the bosses 105b and 105a, respectively.

The fixing member for the condenser lens 101 and the seat portion 103 may be, for example, a molded article of an acrylic resin or a polycarbonate resin, and for the optical housing 102, for example, an aluminum die-casting may be used. The seat portion 103 may protrude integrally with the optical housing 102.

If the condenser lens-holding surface of the seat for bonding of the housing is rectangular as in a conventional lens-fixing structure, the beams passing through the position corresponding to the edges (ridges) of the seat portion 103 have to pass through the portion spanning over the portion of the condenser lens in contact with the housing and the portion not in contact with the housing for a long distance, because the beams and the ridge lines of the seat are substantially parallel to each other. Accordingly, the beams are largely affected by a temperature deviation in the condenser lens with respect to the distance, and hence, image degradation easily occurs in the corresponding portion due to a local disorder in the optical characteristics.

In the first embodiment, however, as shown in FIG. 1, the shape of the condenser lens-holding surface of the seat portion 103 for bonding is different from the conventional rectangular shape, and is a trapezoidal shape in horizontal cross section, so that the shape of the edges (ridges) of the bonding side end face (condenser lens-holding surface) are not substantially parallel to the beams passing through the position.

In other words, the beams passing through the condenser lens 101 are directed from a polygon mirror 42 to a reflector 45, while being scanned. The beams A and B enter into a relatively central area of the lens surface on the light source side of the condenser lens 101, and are output from the lens surface on the photoconductor side of the condenser lens, with the beams deviated from the incident position on the lens surface on the light source side toward the outside of the lens (lens end side). Therefore, as shown in FIG. 1, the beam A passes from the bottom upward to the left side with a certain angle of inclination, and the beam B passes from the bottom upward to the right side with a certain angle of inclination. On the other hand, the condenser lens-holding surface of the seat portion 103 has a trapezoidal shape, with the photoconductor side being the upper side, and the light source side being the bottom side. In FIG. 1, the ridge line corresponding to the beam A inclines rightward from the bottom toward the top, and the ridge line corresponding to the beam B inclines leftward from the bottom toward the top, as the edges (ridges) of the bonding side end face (the condenser lens-holding surface).

Accordingly, even when there is a temperature deviation in the condenser lens at the boundary between the portion in contact with (in a strict sense, adjacent to) the housing and the portion not in contact with the housing, and a deviation occurs in the refractive index of the condenser lens 101, the beams A and B passing through the edges (ridges) of the seat portion 103 are hardly affected by the temperature deviation. This is because, distances X_{A} and X_{B} for which the condenser lens 101 passes through the temperature deviated portion becomes shorter than the distance when the seat has the conventional rectangular shape. Consequently, the conventional problem, that is, degradation of the local optical characteristics of the condenser lens and degradation of the output image can be solved.

FIG. 3 depicts a second embodiment, and is a plan view of a fixing structure for fixing a long condenser lens 101 having a semi-cylindrical planar shape to the seat portion 103 of the housing. Like parts as in FIG. 1 are designated with like reference numerals. Also in the second embodiment, the shape of the condenser lens-holding surface of the seat portion 103 of the housing for bonding the condenser lens is different from the conventional rectangular shape, and is a polygonal shape of at least a hexagon, in which the end ridge shape is a non-linear shape, with a central bent portion protruding outward. That is, the end ridge shape is not substantially parallel to the beams passing through the position, and not a straight line. More specifically, in FIG. 3, the ridge corresponding to the beam A is formed of a ridge line inclined leftward from the bottom upward, and a ridge line inclined rightward from the bottom upward, at an angle larger than the angle of inclination of the beam A. The ridge corresponding to the beam B is formed of a ridge line inclined rightward from the bottom upward, and a ridge line inclined leftward from the bottom upward in FIG. 3, at an angle larger than the angle of inclination of the beam B.

Also in this embodiment, the shape of the condenser lens-holding surface of the seat of the housing for bonding the condenser lens is such that the edges (ridges) thereof are substantially not parallel to the beams passing through the position. Therefore, as in the first embodiment, problems in the conventional art can be solved. Furthermore, because the shape of the seat can be formed without forming the corner thereof with an acute angle, the adhesive can be uniformly spread, thereby bonding the condenser lens more stably than in the first embodiment.

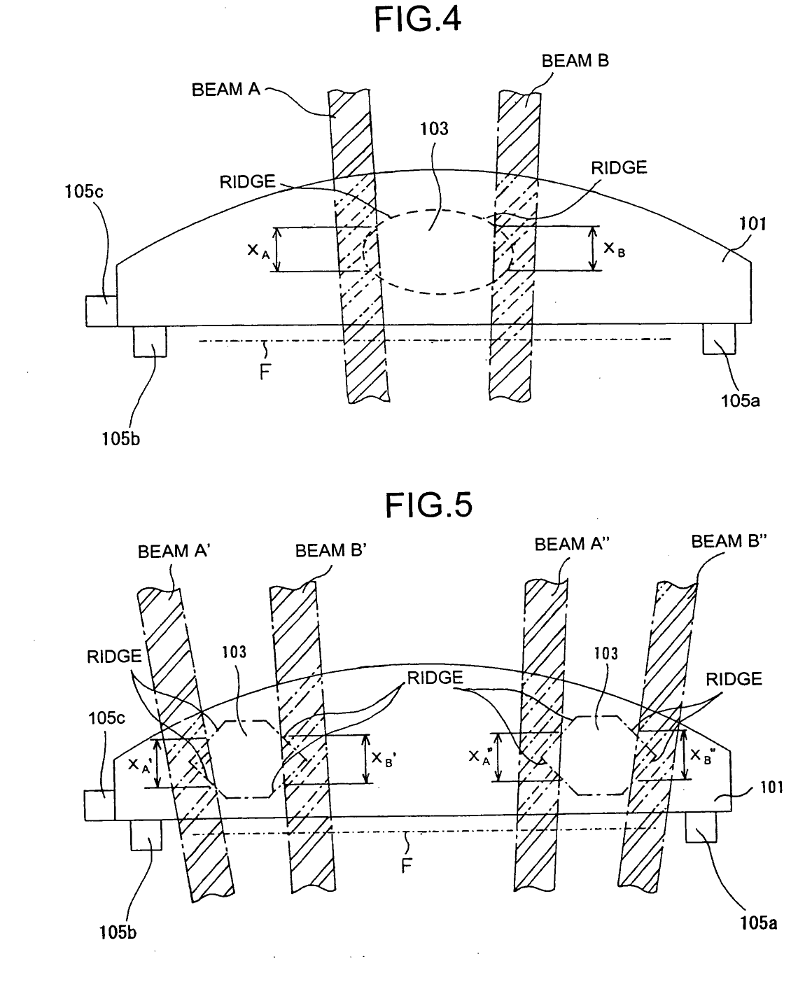

FIG. 4 depicts a third embodiment, and is a plan view of the fixing structure for fixing the longitudinal condenser lens 101 having a semi-cylindrical planar shape to the seat portion 103 of the housing. Like parts as in FIG. 1 are designated with like reference numerals. In the third embodiment, the shape of the condenser lens-holding surface of the seat portion 103 of the housing for bonding the condenser lens is elliptic, such that the end ridge shape thereof are substantially not parallel to the beams passing through the position, and substantially are in a circular shape.

In the third embodiment, the shape of the condenser lens-holding surface of the seat of the housing for bonding the condenser lens is different from the conventional rectangular shape, in that the ends thereof are substantially not parallel to the beams passing through the position. Accordingly, as in the first embodiment, problems in the conventional art can be solved. Furthermore, because the shape of the seat can be formed without forming the corner thereof with an acute angle, the adhesive can be uniformly spread, thereby bonding the condenser lens more stably than in the first embodiment.

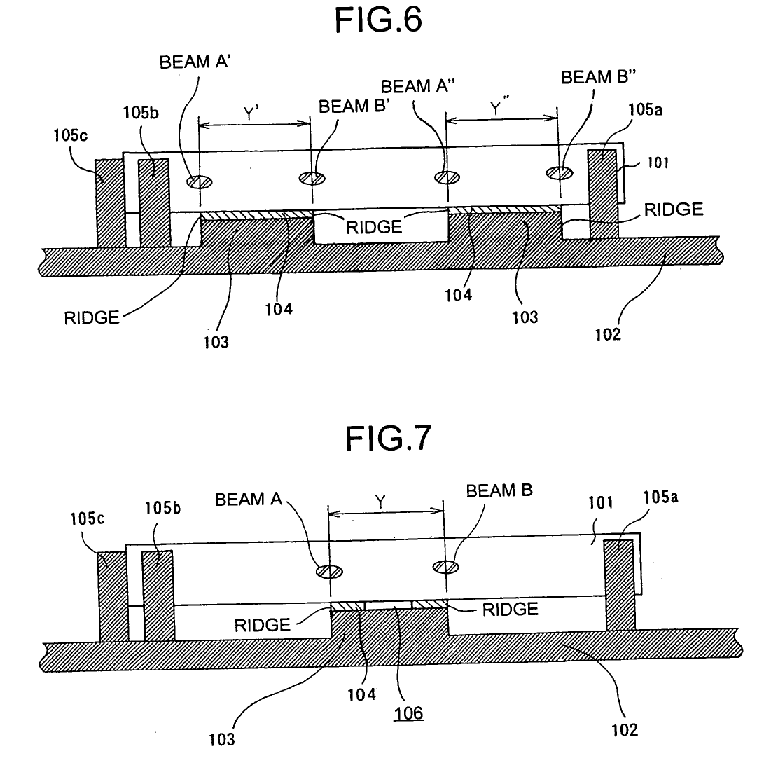

FIG. 5 depicts a fourth embodiment, and is a plan view of the fixing structure for fixing the longitudinal condenser lens 101 having a semi-cylindrical planar shape to the seat portion 103 of the housing, and FIG. 6 is a cross section thereof. In the fourth embodiment, the bonding part (the seat portion 103) for bonding the condenser lens 101 to the housing is provided in a plurality of positions in the longitudinal direction. The shape of the respective seats of the housing for bonding the condenser lens is different from the conventional rectangular shape as in the first embodiment, in that the ends thereof are substantially not parallel to the beams passing through the position.

In the case of bonding the condenser lens at a single point at the center like the first embodiment, particularly when the condenser lens has a lengthy shape, the position (posture) of the condenser lens may not be stabile in the longitudinal direction. Therefore, by bonding the condenser lens at a plurality of positions in the longitudinal direction as in the fourth embodiment, the the condenser lens after bonding and fixing becomes stable. When the bonding position is shifted from the center of the condenser lens in the longitudinal direction, the angle of the beams passing through the positions corresponds thereto. Therefore, the end shape of the seat of the housing for bonding the lens is made substantially not parallel to the beams, to match with the angle of the beams at the position.

As explained in the above embodiments, according to the present invention, the shape of the seat of the housing for bonding the condenser lens is different from the conventional rectangular shape, so that the edges (ridges) thereof are substantially not parallel to the beams passing through the position. Therefore, even when there is a temperature deviation in the condenser lens at the boundary between the portion in contact with the housing and the portion not in contact with the housing, and a deviation occurs in the refractive index of the condenser lens, the beams passing through the edges (ridges) of the seat are hardly affected by the temperature deviation, because the distance for which the condenser lens passes the temperature deviated portion becomes shorter than the distance when the seat has the conventional rectangular shape. Accordingly, the conventional problem, that is, degradation of the local optical characteristics of the condenser lens and degradation of the output image can be solved. Therefore, according to the present invention, even when the use mode of the image forming apparatus changes, and the environmental temperature around the housing changes suddenly, high quality images can be stably formed.

When the end ridge shape of the seat of the housing for bonding the condenser lens is not a linear shape, the problem of degradation of the output image due to a sudden change in the environmental temperature around the housing as in the conventional art can be prevented. Furthermore, because the shape of the seat can be formed without forming the corner thereof with an acute angle, the adhesive can be uniformly spread, thereby bonding the condenser lens more stably than in the first embodiment.

When the end ridge shape of the seat of the housing for bonding the condenser lens is substantially a circular shape, the problem of degradation of the output image due to a sudden change in the environmental temperature around the housing as in the conventional art can be prevented. Furthermore, because the shape of the seat can be formed without forming the corner thereof with an acute angle, the adhesive can be uniformly spread, thereby bonding the condenser lens more stably than in the first embodiment.

When the condenser lens is bonded at a plurality of positions in the longitudinal direction, the problem of degradation of the output image due to a sudden change in the environmental temperature around the housing as in the conventional art can be prevented. Furthermore, the condenser lens can be bonded and fixed to the housing more stably, than in the case of bonding at a single point in the center.

In the present invention, heat transfer from the seat portion 103 to the condenser lens 101 is addressed as a problem. Heat may be transferred in twoways, that is, heat transfer due to a direct contact of the seat portion 103 and the condenser lens 101, and heat transfer due to transfer of radiant heat from the seat portion 103. In other words, when the condenser lens 101 is fitted by bonding to the condenser lens-holding surface of the seat portion 103, the condenser lens 101 and the condenser lens-holding surface of the seat portion 103 are adjacent. Therefore, the condenser lens 101 is mainly affected by the radiant heat from the seat portion 103. When the condenser lens 101 is fitted to the condenser lens-holding surface of the seat portion 103 to come into direct contact with each other, the condenser lens 101 and the condenser lens-holding surface of the seat portion 103 are in direct contact. Therefore, the condenser lens 101 is affected by heat transfer due to the direct contact with the seat portion 103 and the radiant heat from the seat portion 103. Adjacent is when the condenser lens 101 is not direct contact with the seat portion 103, however, the condenser lens 101 is arranged close to the seat portion 103 to the extent that the condenser lens 101 is affected by the radiant heat from the seat portion 103. For example, the distance between the condenser lens 101 and the condenser lens-holding surface of the seat portion 103 is less than 1 mm (millimeter).

In the present invention, there is the effect that the output images are hardly affected by the thermal environment change around the optical housing, in both these cases.

The fifth embodiment is a first modification example of the first embodiment, and only the bonding state using the adhesive 104 is different.

FIG. 7 is a cross section of the fixing structure for fixing the long condenser lens 101 having a semi-cylindrical planar shape to the seat portion 103 of the housing. The plan view in the fifth embodiment is the same as that shown in FIG. 1. In the fifth embodiment, a part of the condenser lens-holding surface of the seat portion 103 and a part of the central part of the condenser lens 101 are bonded together by the adhesive 104, however, there is a gap 106 between the condenser lens-holding surface of the seat portion 103 and the condenser lens 101, and the adhesive 104 is not filled in the gap 106. The condenser lens 101 and the seat portion 103 do not come into direct contact with each other because of the adhesive 104 between the condenser lens 101 and the seat portion 103.

Also, the same effects as in the first embodiment can be obtained in the fifth embodiment. That is, the condenser lens 101 is thermally affected by the radiant heat from the seat portion 103 at a portion adjacent to the seat portion 103, regardless of the portion having the adhesive 104 and the portion without the adhesive (the gap 106). Therefore, a temperature deviation occurs in the condenser lens 101 at the boundary between the portion adjacent to the seat portion 103 and the portion not adjacent to the seat portion 103, thereby causing a deviation in the refractive index of the condenser lens 101. However, the beams A and B passing through the edges (ridges) of the seat portion 103 are hardly affected by the temperature deviation, because distances X_{A} and X_{B} (see FIG. 1) for which the beams A and B pass through the temperature deviated portion of the condenser lens 101 are shorter than the distance when the seat has the conventional rectangular shape. Accordingly, the conventional problem, that is, degradation of the local optical characteristics of the condenser lens and degradation of the output image can be solved.

The sixth embodiment is a second modification example of the first embodiment, and the adhesive 104 is not used.

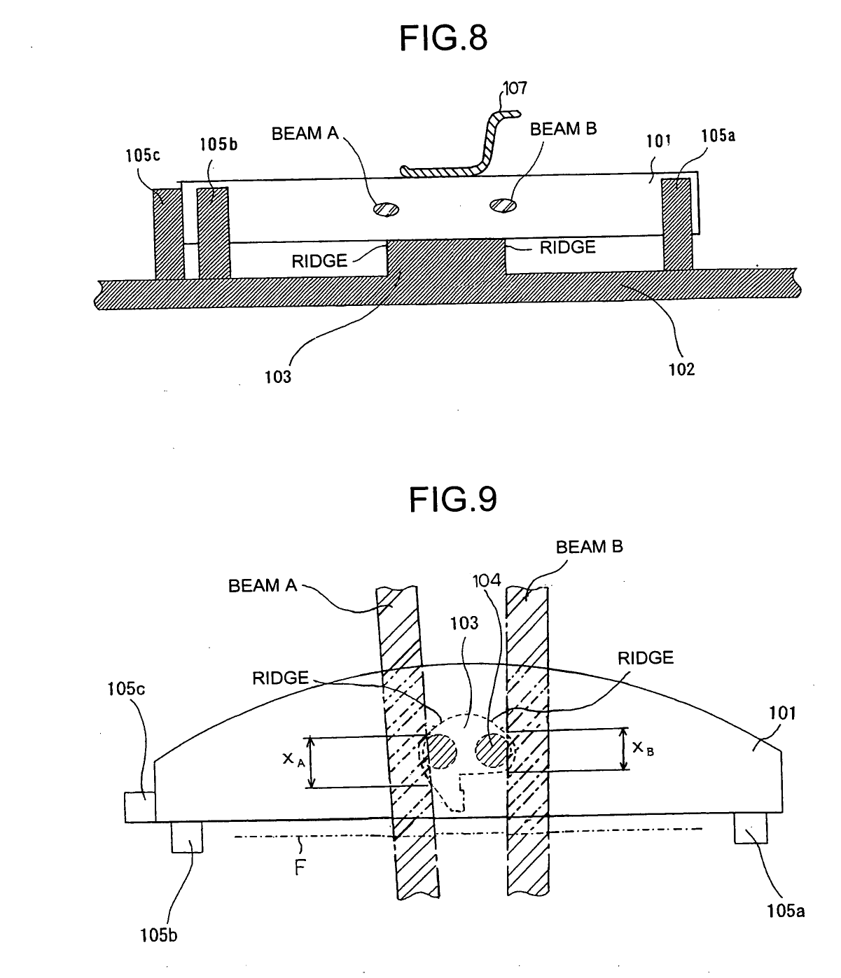

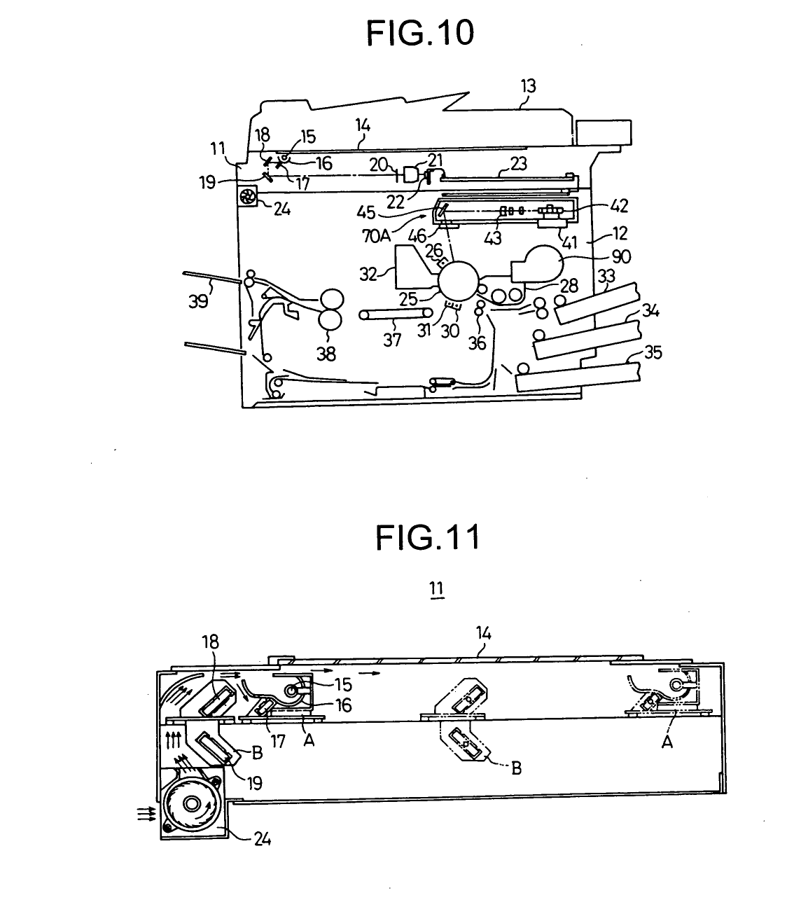

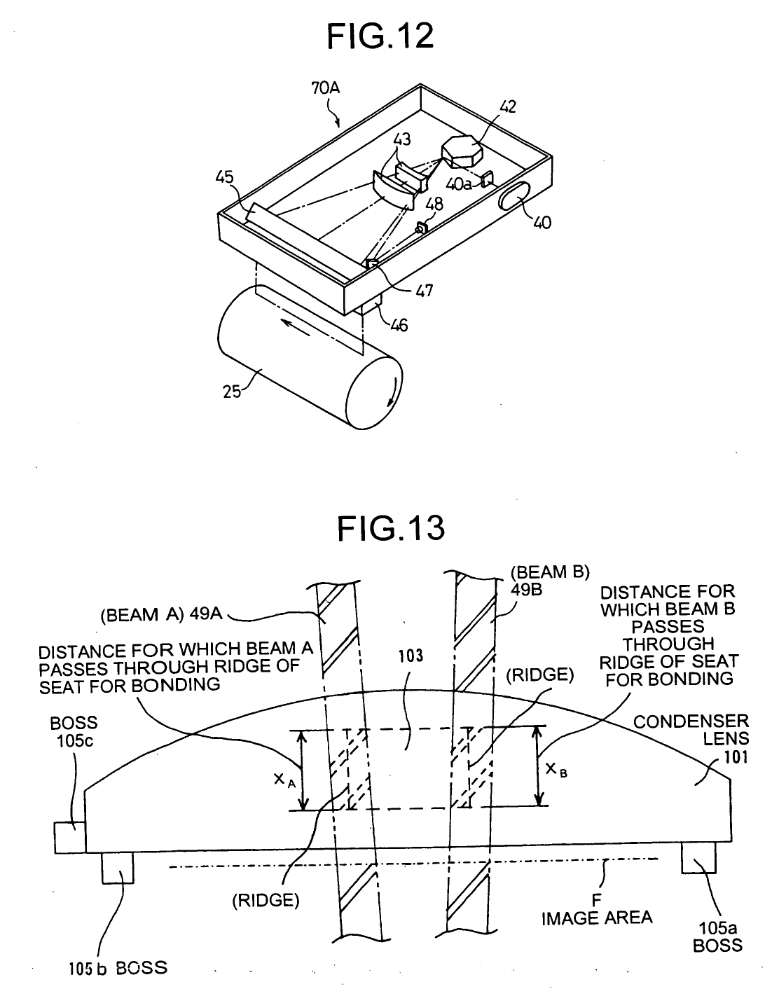

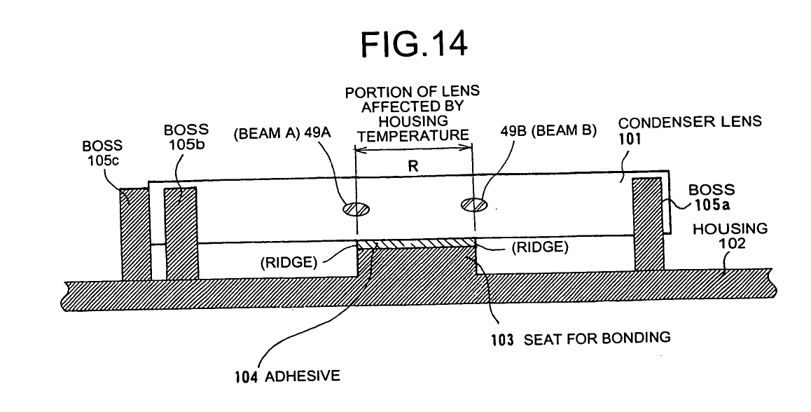

FIG. 8 is a cross section of the fixing structure for fixing the long condenser lens 101 having a semi-cylindrical planar shape to the seat portion 103 of the housing. The plan view in the sixth embodiment is the same as that shown in FIG. 1. In the sixth embodiment, the condenser lens 101 is pressed against and fixed to the condenser lens-holding surface of the seat portion 103 by pressing downward using an elastic member 107 such as a plate spring that is arranged above the condenser lens 101. The condenser lens-holding surface of the seat portion 103 and the central part of the condenser lens 101 are brought into direct contact with each other.

The same effects as in the first embodiment can be obtained in the sixth embodiment. That is, the condenser lens 101 is thermally affected by direct heat transfer and the radiant heat from the seat portion 103 at a portion in direct contact with the seat portion 103. Therefore, a temperature deviation occurs in the condenser lens 101 at the boundary between the portion in direct contact with the seat portion 103 and the portion not in direct contact with the seat portion 103, thereby causing a deviation in the refractive index of the condenser lens 101. However, the beams A and B passing through the edges (ridges) of the seat portion 103 are hardly affected by the temperature deviation, because distances X_{A} and X_{B} (see FIG. 1) for which the beams A and B pass through the temperature deviated portion of the condenser lens 101 become shorter than the distance when the seat has the conventional rectangular shape. Accordingly, the conventional problem, that is, degradation of the local optical characteristics of the condenser lens and degradation of the output image can be solved.

In the present invention, it is not necessary that the shape of the condenser lens-holding surface of the seat portion 103 is symmetric or point symmetric.

FIG. 9 is a plan view of the fixing structure for fixing the long condenser lens (scanning lens) 101 having a semi-cylindrical planar shape (in horizontal cross section) and a short columnar shape to the optical housing, where the seat portion 103 (condenser lens-holding surface) is indicated by a dotted line. A part of the condenser lens-holding surface of the seat portion 103 and the central part of the condenser lens 101 are bonded by the adhesive 104, and hatched areas indicate the bonded areas.

The shape of the condenser lens-holding surface of the seat portion 103 is obtained by combining the second embodiment (hexagonal shape) and the third embodiment (elliptical shape), from which the right bottom part of the condenser lens-holding surface is cut away.

The same effects as in the second and the third embodiments can be obtained in the seventh embodiment. That is, the condenser lens 101 is thermally affected by the radiant heat from the seat portion 103 at a portion adjacent to the seat portion 103. Therefore, a temperature deviation occurs in the condenser lens 101 at the boundary between the portion in direct contact with the seat portion 103 and the portion not in direct contact with the seat portion 103, thereby causing a deviation in the refractive index of the condenser lens 101. However, the beams A and B passing through the edges (ridges) of the seat portion 103 are hardly affected by the temperature deviation, because distances X_{A} and X_{B} (see FIG. 1) for which the beams A and B pass through the temperature deviated portion of the condenser lens 101 becomes shorter than the distance when the seat has the conventional rectangular shape. Accordingly, the conventional problem, that is, degradation of the local optical characteristics of the condenser lens and degradation of the output image can be solved.

In any of the embodiments above, if the distance between the condenser lens 101 and the optical housing 102 is short, the condenser lens 101 is affected by the radiant heat from the optical housing 102, which is not preferable. Accordingly, it is necessary that the height of the seat portion 103 from the bottom of the optical housing 102 be such that the adverse effect on the condenser lens 101 due to the radiant heat from the optical housing 102 can be prevented. For example, when the optical housing 102 is an aluminum die casting, it is desired that the height of the seat portion 103 is at least 1 mm.

The optical scanner explained in the first to the fourth embodiments can be installed and applied to an electro-photographic copying machine, a laser beam printer, and a facsimile machine, as the image forming apparatus that forms an image on a recording medium. Even when the environmental temperature around the housing suddenly changes, a high quality image can be stably formed as an output of the electro-photographic copying machine, the laser beam printer, or the facsimile machine.

According to the optical scanner and the image forming apparatus of the present invention, the optical scanner having the condenser lens-fixing structure in the scanning and imaging optical system is not affected by the temperature and environmental changes around the optical housing. Accordingly, high quality images can be stably formed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical scanner comprising:
a light source that emits light beams;
an optical deflector that deflects the light beams;
an optical housing;
a photoconductor; and
a scanning and imaging optical system fitted to the optical housing, and into which deflected light beams enter, and which condenses the light beams as an optical spot on the photoconductor; wherein
the scanning and imaging optical system includes a condenser lens that is longer in a horizontal scanning direction, the light beams passing through the condenser lens,
the optical housing includes a seat that has a holding surface for holding the condenser lens, and
a ridge at each of opposite ends on the holding surface of the seat is linear in the horizontal scanning direction, and a portion of each ridge immediately below where the light beams pass through the condenser lens is substantially not parallel to a path of the light beams.

2. The optical scanner according to claim 1, wherein
the ridge is non-linear.

3. The optical scanner according to claim 1, wherein
the ridge is substantially circular.

4. The optical scanner according to claim 1, wherein
the seat holds the condenser lens only at a central portion in the longitudinal direction.

5. The optical scanner according to claim 1, wherein
the seat holds the condenser lens at a plurality of positions in the longitudinal direction.

6. The optical scanner according to claim 1, wherein
the condenser lens is bonded to the holding surface of the seat.

7. The optical scanner according to claim 1, wherein
the condenser lens is fixed to the seat by pressing using an elastic member.

8. The optical scanner according to claim 1, wherein
the optical housing includes a plurality of seats each of which has a holding surface for holding the condenser lens.

9. An image forming apparatus, comprising:
an image forming unit equipped with an optical scanner, wherein the optical scanner includes
a light source that emits light beams;
an optical deflector that deflects the light beams;
an optical housing;
a photoconductor; and
a scanning and imaging optical system fitted to the optical housing, and into which deflected light beams enter, and which condenses the light beams as an optical spot on the photoconductor; wherein
the scanning and imaging optical system includes a condenser lens that is longer in a horizontal scanning direction, the light beams passing through the condenser lens,
the optical housing includes a seat that has a holding surface for holding the condenser lens, and
a ridge at each of opposite ends on the holding surface of the seat is linear in the horizontal scanning direction, and a portion of each ridge immediately below where the light beams pass through the condenser lens is substantially not parallel to a path of the light beams.

10. The image forming apparatus according to claim 9, wherein
the image forming unit is an electro-photographic copying machine.

11. The image forming apparatus according to claim 9, wherein
the image forming unit is a laser beam printer.

12. The image forming apparatus according to claim 9, wherein
the image forming unit is a facsimile machine.
